(19) United States
(12) Patent Application Publication
(10) Pub. No.: US 2025/0278225 A1
(43) Pub. Date: Sep. 4, 2025

(54) IMAGE FORMING DEVICE, CONTROL METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Akihiko SATOMI, Shiojiri (JP)

(21) Appl. No.: 19/063,395

(22) Filed: Feb. 26, 2025

(30) Foreign Application Priority Data
Feb. 29, 2024 (JP) 2024-029622

(51) Int. Cl. G06F 3/12

(52) U.S. Cl. CPC G06F 3/1238; G06F 3/1205; G06F 3/1222; G06F 3/129; G06F 3/1286

(57) ABSTRACT

The multifunction peripheral 2 includes an authentication information reception unit 22 that receives authentication information from a user terminal 3, and a printing unit 25 that receives a print job from the user terminal 3, executes printing of the print job in a direct print mode 25a when the authentication information received by the authentication information reception unit 22 satisfies a first condition, and executes printing of the print job in an authentication print mode 25b when the authentication information received by the authentication information reception unit 22 satisfies a second condition different from the first condition.

The present application is based on, and claims priority from JP Application Serial Number 2024-029622, filed Feb. 29, 2024, the disclosure of which is hereby incorporated by reference herein in its entirety.

### BACKGROUND

### 1. Technical Field

The present disclosure relates to an image forming device, a control method, and a non-transitory computer-readable storage medium storing a program.

### 2. Related Art

JP-A-2022-105525 discloses a reservation printing function of a printing device such as a multifunction peripheral and a printer. The reservation printing function is also referred to as an authentication print mode and is a function of preventing a printed material from being left in the printing device by temporarily reserving printing data input from an external device to a printing device via a network and outputting the printing data only when a user gives a print instruction via an operation unit of the printing device.

However, when printing is performed using an OS standard printer driver, a direct print mode and the authentication print mode cannot be mixed.

### SUMMARY

There is provided an image forming device including:
an authentication information reception unit configured to receive authentication information from a user terminal; and
a printing unit configured to receive a print job from the user terminal, to execute printing of the print job in a direct print mode when the authentication information received by the authentication information reception unit satisfies a first condition, and to execute printing of the print job in an authentication print mode when the authentication information received by the authentication information reception unit satisfies a second condition different from the first condition.

There is provided a method for controlling an image forming device, and the method includes:
receiving authentication information from a user terminal; and
receiving a print job from the user terminal, executing printing of the print job in a direct print mode when the received authentication information satisfies a first condition, and executing the printing of the print job in an authentication print mode when the received authentication information satisfies a second condition different from the first condition.

There is provided a non-transitory computer-readable storage medium storing a program, and the program causes an image forming device to execute:
receiving authentication information from a user terminal; and
receiving a print job from the user terminal, executing printing of the print job in a direct print mode when the received authentication information satisfies a first condition, and executing the printing of the print job in an authentication print mode when the received authentication information satisfies a second condition different from the first condition.

### BRIEF DESCRIPTION OF THE DRAWINGS

FIG. 1 is a schematic diagram of a printing system (first embodiment).

FIG. 2 is a block diagram of a user terminal (first embodiment).

FIG. 3 is a block diagram of a multifunction peripheral (first embodiment).

FIG. 4 is a control flow of the printing system (first embodiment).

FIG. 5 is a schematic diagram of a printing system (second embodiment).

FIG. 6 is a block diagram of a multifunction peripheral (second embodiment).

FIG. 7 is a block diagram of an LDAP server second embodiment).

FIG. 8 is a control flow of the printing system (second embodiment).

### DESCRIPTION OF EMBODIMENTS

Hereinafter, the disclosure will be described through embodiments of the disclosure, but the disclosure according to the claims is not limited to the following embodiments. All of configurations described in the embodiments are not necessarily essential as means for solving the problem. To clarify the description, omissions and simplifications have been made as appropriate in the description and the drawings below. In the drawings, the same elements are denoted by the same reference numerals, and the redundant description thereof is omitted as necessary.

### First Embodiment

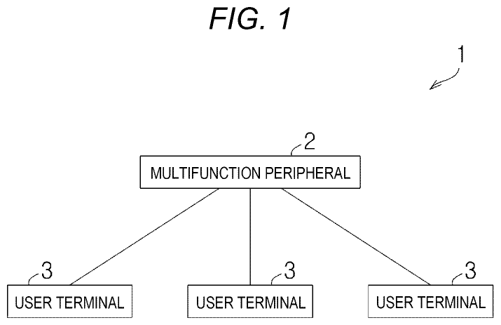

Hereinafter, a first embodiment of the present disclosure will be described with reference to FIGS. 1 to 4. FIG. 1 is a schematic diagram of a printing system 1. As shown in FIG. 1, the printing system 1 includes a multifunction peripheral 2 and a plurality of user terminals 3. Each user terminal 3 is typically configured to perform two-way communication with the multifunction peripheral 2 via a local area network (LAN). The printing system 1 may include a plurality of multifunction peripherals 2. The printing system 1 may include only one user terminal instead of including a plurality of user terminals 3. The number of user terminals 3 provided in the printing system 1 is not limited. The configurations of the user terminals 3 are the same, and thus one user terminal 3 will be representatively described below, and the description of the other user terminals 3 will be omitted.

In the present embodiment, the multifunction peripheral 2 has a user restriction function that requires authentication when performing printing. Therefore, when the multifunction peripheral 2 is accessed from the user terminal 3 and printing is performed using the multifunction peripheral 2, it is required to input authentication information to the user terminal 3. The multifunction peripheral 2 is configured to determine whether to execute printing based on the authentication information received from the user terminal 3.

### User Terminal 3

The user terminal 3 is typically a personal digital assistant such as a smartphone and a tablet. In this type of personal digital assistant, a unique printer driver provided by a vendor of the multifunction peripheral 2 is not installed, and printing using the multifunction peripheral 2 is executed via an OS standard printer driver attached to an operating system (OS) installed in the personal digital assistant. The user terminal 3 may be a laptop personal computer or a desktop personal computer instead of the personal digital assistant.

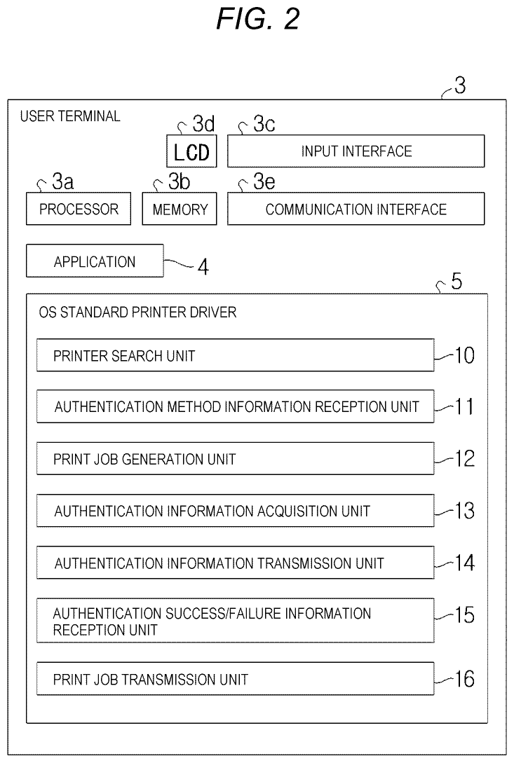

As shown in FIG. 2, the user terminal 3 includes a processor 3a, a memory 3b, an input interface 3c, a liquid crystal display (LCD) 3d, and a communication interface 3e. The user terminal 3 communicates with the multifunction peripheral 2 via the communication interface 3e. The processor 3a can access the memory 3b. The processor 3a reads and executes a program stored in the memory 3b. Accordingly, the program causes hardware such as the processor 3a to function as an application 4 and an OS standard printer driver 5.

The memory 3b is implemented by a read only memory (ROM), a random access memory (RAM), a hard disc drive (HDD), or a solid state drive (SSD).

The input interface 3c is a unit for receiving an operation performed by a user. The input interface 3c is typically implemented by a touch panel, a keyboard, or a pointing device.

The LCD 3d is a unit for displaying visual information. The user terminal 3 may include an organic light emitting diode (OLED) instead of the LCD 3d.

The application 4 generates user data such as image data and document data based on an input operation input via the input interface 3c. The application 4 outputs the user data to the OS standard printer driver 5 in accordance with a print instruction from the user.

The OS standard printer driver 5 is also called a universal printer driver (registered trademark) or AirPrint (registered trademark). The OS standard printer driver 5 includes a printer search unit 10, an authentication method information reception unit 11, a print job generation unit 12, an authentication information acquisition unit 13, an authentication information transmission unit 14, an authentication success/failure information reception unit 15, and a print job transmission unit 16.

The printer search unit 10 searches for the multifunction peripheral 2 in the network to which the user terminal 3 belongs.

The authentication method information reception unit 11 receives authentication method information from the multifunction peripheral 2 identified by the search performed by the printer search unit 10. The authentication method information indicates the type of authentication information input by the user terminal 3 when the multifunction peripheral 2 is accessed from the user terminal 3 and printing is performed using the multifunction peripheral 2.

Examples of the type of authentication information include a combination of a user account name and a password corresponding to the user account name, a secret identification number including a number of about six to ten digits, and other authentication information. The secret identification number is also referred to as a personal identification number (PIN).

The print job generation unit 12 generates a print job including user data input from the application 4. In addition to the user data, the print job may include print settings such as the number of printing copies and a size of a printing sheet.

The authentication information acquisition unit 13 prompts the user to input the authentication information by displaying an authentication information input screen in the LCD 3d. The authentication information acquisition unit 13 acquires the authentication information input by the user via the input interface 3c.

The authentication information transmission unit 14 transmits the authentication information acquired by the authentication information acquisition unit 13 to the multifunction peripheral 2.

The authentication success/failure information reception unit 15 receives authentication success/failure information from the multifunction peripheral 2. The authentication success/failure information indicates whether to access the multifunction peripheral 2 from the user terminal 3 and perform printing using the multifunction peripheral 2.

The print job transmission unit 16 transmits the print job to the multifunction peripheral 2. Specifically, the print job transmission unit 16 converts user data included in the print job into printing data, and transmits the converted print job to the multifunction peripheral 2.

### Multifunction Peripheral 2

The multifunction peripheral 2 is a specific example of an image forming device. The multifunction peripheral 2 has an image reading function and a printing function. The image forming device may be a printer having only a printing function instead of the multifunction peripheral 2.

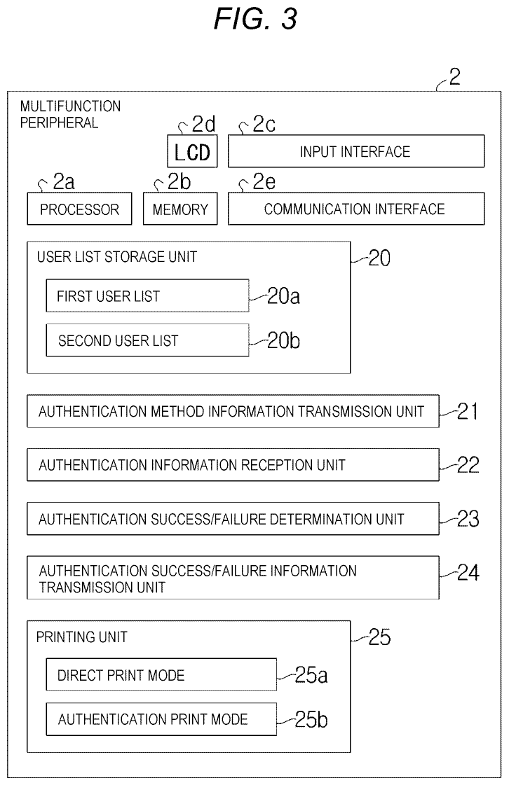

As shown in FIG. 3, the multifunction peripheral 2 includes a processor 2a, a memory 2b, an input interface 2c, an LCD 2d, and a communication interface 2e. The multifunction peripheral 2 communicates with the user terminal 3 via the communication interface 2e. The processor 2a can access the memory 2b. The processor 2a reads and executes a program stored in the memory 2b. Accordingly, the program causes hardware such as the processor 2a to function as an authentication method information transmission unit 21, an authentication information reception unit 22, an authentication success/failure determination unit 23, an authentication success/failure information transmission unit 24, and a printing unit 25. The memory 2b functions as a user list storage unit 20.

The memory 2b is implemented by a read only memory (ROM), a random access memory (RAM), a hard disc drive (HDD), or a solid state drive (SSD).

The input interface 2c is a unit for receiving an operation performed by the user. The input interface 2c is typically implemented by a touch panel.

The LCD 2d is a unit for displaying visual information. The multifunction peripheral 2 may include an organic light emitting diode (OLED) instead of the LCD 2d.

The user list storage unit 20 stores a first user list 20a and a second user list 20b.

The first user list 20a is a specific example of a first list. The first user list 20a includes a plurality of pieces of user information. Each user information includes, for example, a user account name, a password, and a secret identification number. The first user list 20a typically includes 10 pieces of user information. However, the number of pieces of user information included in the first user list 20a is not limited.

The second user list 20b is a specific example of a second list. The second user list 20b includes a plurality of pieces of user information. Each user information includes, for example, a user account name, a password, and a secret identification number. The second user list 20b typically includes 1000 pieces of user information. However, the number of pieces of user information included in the second user list 20b is not limited.

The user information is also referred to as user account information. The user list is also referred to as a user account list.

A user corresponding to the first user list 20a is permitted to use more functions of the multifunction peripheral 2 than a user corresponding to the second user list 20b. For example, when the multifunction peripheral 2 has an image reading function, a printing function, and other functions, the user corresponding to the first user list 20a is permitted to use all the functions of the multifunction peripheral 2, whereas the user corresponding to the second user list 20b is permitted to use only the printing function.

A plurality of pieces of user information included in the first user list 20a and a plurality of pieces of user information included in the second user list 20b may partially overlap. In this case, typically, the second user list 20b may include all of the plurality of pieces of user information included in the first user list 20a.

Each user information includes a user account name, a password, and a secret identification number. However, each user information may include only a user account name and a password, or may include only a secret identification number.

The authentication method information transmission unit 21 transmits the authentication method information stored in the memory 2b to the user terminal 3.

The authentication information reception unit 22 receives the authentication information from the authentication information transmission unit 14 of the user terminal 3.

The authentication success/failure determination unit 23 determines success or failure of authentication based on the authentication information received by the authentication information reception unit 22. Specifically, the authentication success/failure determination unit 23 collates the authentication information received by the authentication information reception unit 22 with the first user list 20a and the second user list 20b in the user list storage unit 20, and when the authentication information received by the authentication information reception unit 22 corresponds to at least one of the first user list 20a and the second user list 20b, the authentication success/failure determination unit 23 generates authentication success/failure information indicating that the user corresponding to the authentication information received by the authentication information reception unit 22 is permitted to use the multifunction peripheral 2. On the other hand, the authentication success/failure determination unit 23 collates the authentication information received by the authentication information reception unit 22 with the first user list 20a and the second user list 20b in the user list storage unit 20, and when the authentication information received by the authentication information reception unit 22 does not correspond to the first user list 20a and the second user list 20b, the authentication success/failure determination unit 23 generates authentication success/failure information indicating that the user corresponding to the authentication information received by the authentication information reception unit 22 is not permitted to use the multifunction peripheral 2.

The expression the authentication that information received by the authentication information reception unit 22 corresponds to at least one of the first user list 20a and the second user list 20b means that the authentication information received by the authentication information reception unit 22 corresponds to any one of the plurality of pieces of user information included in the first user list 20a or the authentication information received by the authentication information reception unit 22 corresponds to any one of the plurality of pieces of user information included in the second user list 20b.

The authentication success/failure information transmission unit 24 transmits the authentication success/failure information generated by the authentication success/failure determination unit 23 to the user terminal 3.

The printing unit 25 executes printing of the print job received from the print job transmission unit 16 of the user terminal 3. Specifically, the printing unit 25 has a direct print mode 25a and an authentication print mode 25b. The printing unit 25 executes printing of the print job in accordance with the direct print mode 25a or the authentication print mode 25b.

Specifically, when the authentication information received by the authentication information reception unit 22 satisfies a first condition, that is, when the authentication information received by the authentication information reception unit 22 corresponds to the first user list 20a, the printing unit 25 executes printing of the print job in accordance with the direct print mode 25a. In contrast, when the authentication information received by the authentication information reception unit 22 satisfies a second condition, that is, when the authentication information received by the authentication information reception unit 22 corresponds to the second user list 20b, the printing unit 25 executes printing of the print job in accordance with the authentication print mode 25b.

The direct print mode 25a is an operation mode in which the user is not requested to perform an authentication operation on the multifunction peripheral 2 before the multifunction peripheral 2 executes the printing of the print job. The authentication operation is a specific example of an operation.

When the printing unit 25 executes the printing of the print job in accordance with the direct print mode 25a, the printing unit 25 executes the printing of the print job received from the print job transmission unit 16 as quickly as possible.

Specifically, when the multifunction peripheral 2 is executing printing of another print job, the printing unit 25 immediately executes the printing of the print job received from the print job transmission unit 16 upon completion of printing of the other print job.

When the multifunction peripheral 2 is executing the printing of another print job and a plurality of print jobs are accumulated, the printing unit 25 immediately executes printing of the print job received from the print job transmission unit 16 upon completion of the other print job and the plurality of accumulated jobs.

When the printing unit 25 is not executing the printing of the print job and does not store the print job, the printing unit 25 immediately executes the printing of the print job received from the print job transmission unit 16.

Here, the authentication operation will be described in detail. As described above, the user performs the authentication operation on the multifunction peripheral 2 in a vicinity of the multifunction peripheral 2. The vicinity of the multifunction peripheral 2 means the vicinity of the multifunction peripheral 2 to the extent that the user himself/herself can reach the multifunction peripheral 2. The authentication operation is typically an operation of inputting authentication information again via the input interface 2c on the authentication information input screen displayed on the LCD 2d of the multifunction peripheral 2. The authentication operation may be performed by, instead of the input operation via the input interface 2c, holding an authentication card owned by the user over an authentication card reader (not shown) provided in the multifunction peripheral 2 to cause the authentication card reader to read authentication information stored in the authentication card.

The authentication print mode 25b is an operation mode in which the user is requested to perform the authentication operation on the multifunction peripheral 2 before the multifunction peripheral 2 executes the printing of the print job.

When the printing unit 25 executes the printing of the print job in accordance with the authentication print mode 25b, the printing unit 25 executes the printing of the print job received from the print job transmission unit 16 when the authentication information input by the authentication operation corresponds to at least one of the first user list 20a and the second user list 20b. When the user is requested to perform the authentication operation in this manner, it is possible to ensure that the user was moved to the vicinity of the multifunction peripheral 2, and thus it is possible to effectively prevent a printed material from being left in the multifunction peripheral 2.

When the authentication information input by the authentication operation does not correspond to the first user list 20a and the second user list 20b, the printing unit 25 does not execute the printing of the print job received from the print job transmission unit 16.

### Control Flow

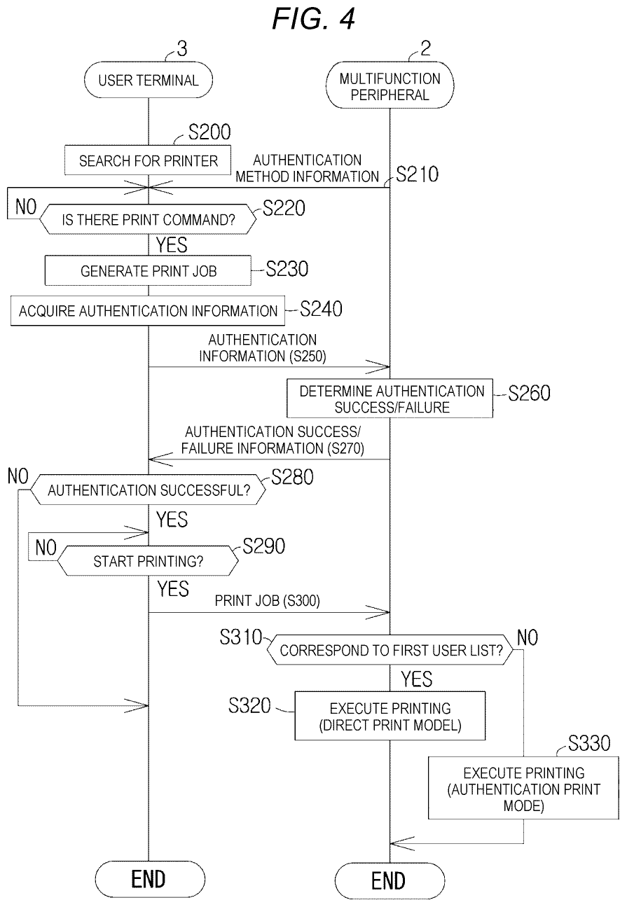

Next, a control flow of the printing system 1 will be described with reference to FIG. 4.

### S200:

First, when the user terminal 3 is connected to a network, the printer search unit 10 of the user terminal 3 searches for the multifunction peripheral 2 in the same network.

### S210:

Next, the authentication method information transmission unit 21 of the multifunction peripheral 2 transmits authentication method information to the authentication method information reception unit 11 of the user terminal 3.

### S220:

Next, the print job generation unit 12 of the user terminal 3 determines whether a print command was output from the application 4. When it is determined that the print command was output from the application 4 (S220: YES), the print job generation unit 12 advances the processing to step S230. On the other hand, when it is determined that the print command is not output from the application 4 (S220: NO), the print job generation unit 12 repeats step S220.

### S230:

Next, the print job generation unit 12 of the user terminal 3 receives user data from the application 4 and generates a print job including the user data.

### S240:

Next, the authentication information acquisition unit 13 of the user terminal 3 prompts the user to input authentication information by displaying an authentication information input screen in the LCD 3d. Then, the authentication information acquisition unit 13 acquires the authentication information input by the user via the input interface 3c.

### S250:

Next, authentication information the transmission unit 14 of the user terminal 3 transmits the authentication information acquired by the authentication information acquisition unit 13 to the authentication information reception unit 22 of the multifunction peripheral 2.

### S260:

Next, the authentication success/failure determination unit 23 of the multifunction peripheral 2 determines success or failure of authentication based on the authentication information received by the authentication information reception unit 22, and generates authentication success/failure information indicating a determination result.

### S270:

Next, the authentication success/failure information transmission unit 24 of the multifunction peripheral 2 transmits the authentication success/failure information generated by the authentication success/failure determination unit 23 to the authentication success/failure information reception unit 15 of the user terminal 3.

### S280:

Next, the print job transmission unit 16 determines, based on the authentication success/failure information, whether the authentication is successful or failed. When the authentication fails (S280: NO), the print job transmission unit 16 ends the processing. On the other hand, when the authentication is successful (S280: YES), the print job transmission unit 16 advances the processing to step S290.

### S290-S300:

In step S290, the print job transmission unit 16 displays a printing start button on the LCD 3d. When the user taps the printing start button (S290: YES), the print job transmission unit 16 transmits the print job to the printing unit 25 of the multifunction peripheral 2 (S300). On the other hand, when the user does not tap the printing start button (S290: NO), the print job transmission unit 16 repeats step S290.

### S310-S330:

Next, the printing unit 25 of the multifunction peripheral 2 determines whether the authentication information received by the authentication information reception unit 22 corresponds to the first user list 20a. When it is determined that the authentication information received by the authentication information reception unit 22 corresponds to the first user list 20a (S310: YES), the printing unit 25 executes the printing of the print job in the direct print mode 25a (S320), and ends the processing. On the other hand, when it is determined that the authentication information received by the authentication information reception unit 22 does not correspond to the first user list 20a (S310: NO), it is determined that the authentication information received by the authentication information reception unit 22 corresponds to the second user list 20b (see step S260), and the printing unit 25 executes the printing of the print job in the authentication print mode 25b (S330) and ends the processing.

The first embodiment of the present disclosure is described above. The above first embodiment has the following features.

The multifunction peripheral 2 includes the authentication information reception unit 22 that receives authentication information from the user terminal 3, and the printing unit 25 that receives a print job from the user terminal 3, executes printing of the print job in the direct print mode 25a when the authentication information received by the authentication information reception unit 22 satisfies a first condition, and executes printing of the print job in the authentication print mode 25b when the authentication information received by the authentication information reception unit 22 satisfies a second condition different from the first condition. According to the above configuration, even when printing is performed using the OS standard printer driver, the direct print mode 25a and the authentication print mode 25b can be mixed.

The direct print mode 25a is an operation mode in which an authentication operation is not requested to be performed on the multifunction peripheral 2 before printing of the print job is executed. The authentication print mode 25b is an operation mode in which an authentication operation is requested to be performed on the multifunction peripheral 2 before executing printing of the print job.

The expression that the authentication information received by the authentication information reception unit 22 satisfies the first condition means that the authentication information received by the authentication information reception unit 22 corresponds to the first user list 20a (first list). The expression that the authentication information received by the authentication information reception unit 22 satisfies the second condition means that the authentication information received by the authentication information reception unit 22 corresponds to the second user list 20b (second list) different from the first user list 20a. According to the above configuration, whether the authentication information received by the authentication information reception unit 22 satisfies the first condition and the second condition can be managed via lists.

When the authentication information received by the authentication information reception unit 22 corresponds to the first user list 20a, use of more functions of the multifunction peripheral 2 can be permitted as compared with a case where the authentication information received by the authentication information reception unit 22 corresponds to the second user list 20b. According to the above configuration, an available function can be set for each user.

The multifunction peripheral 2 further includes the user list storage unit 20 (list storage unit) that stores the first user list 20a and the second user list 20b. According to the above configuration, whether the authentication information received by the authentication information reception unit 22 satisfies the first condition and the second condition can be determined without connecting the multifunction peripheral 2 to an external device.

The printing unit 25 may be configured to execute printing of a print job in the direct print mode 25a when the authentication information received by the authentication information reception unit 22 satisfies the first condition and the second condition at the same time, that is, when the authentication information received by the authentication information reception unit 22 corresponds to both the first user list 20a and the second user list 20b. According to the above configuration, the user corresponding to both the first user list 20a and the second user list 20b can cause the multifunction peripheral 2 to execute printing in the direct print mode 25a.

When the authentication information received by the authentication information reception unit 22 does not satisfy the first condition and the second condition, that is, when the authentication information received by the authentication information reception unit 22 does not correspond to the first user list 20a and the second user list 20b, the printing unit 25 does not execute the printing of the print job. In FIG. 4, when the authentication information received by the authentication information reception unit 22 does not correspond to the first user list 20a and the second user list 20b (S280: NO), the printing unit 25 does not receive the print job from the user terminal 3.

The authentication information reception unit 22 receives the authentication information from the OS standard printer driver 5 of the user terminal 3. According to the above configuration, even when printing is performed using the OS standard printer driver 5, the direct print mode 25a and the authentication print mode 25b can be mixed.

### Second Embodiment

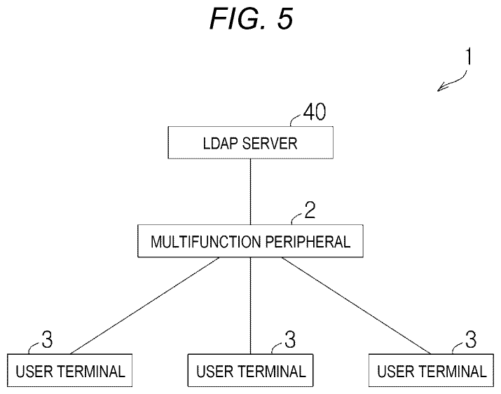

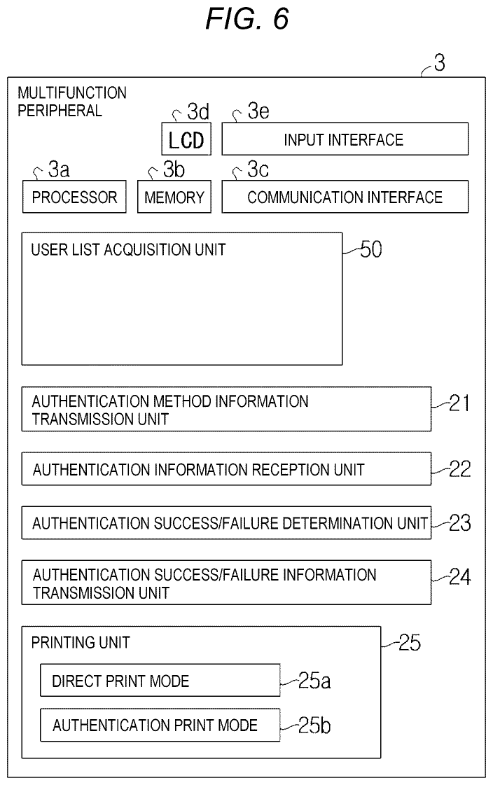

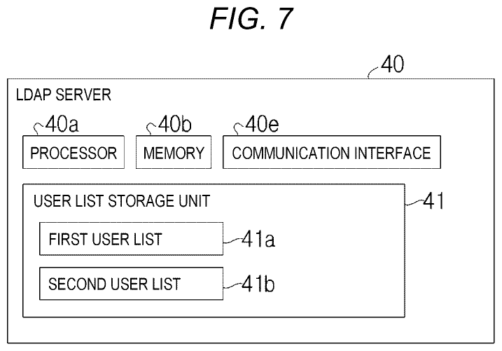

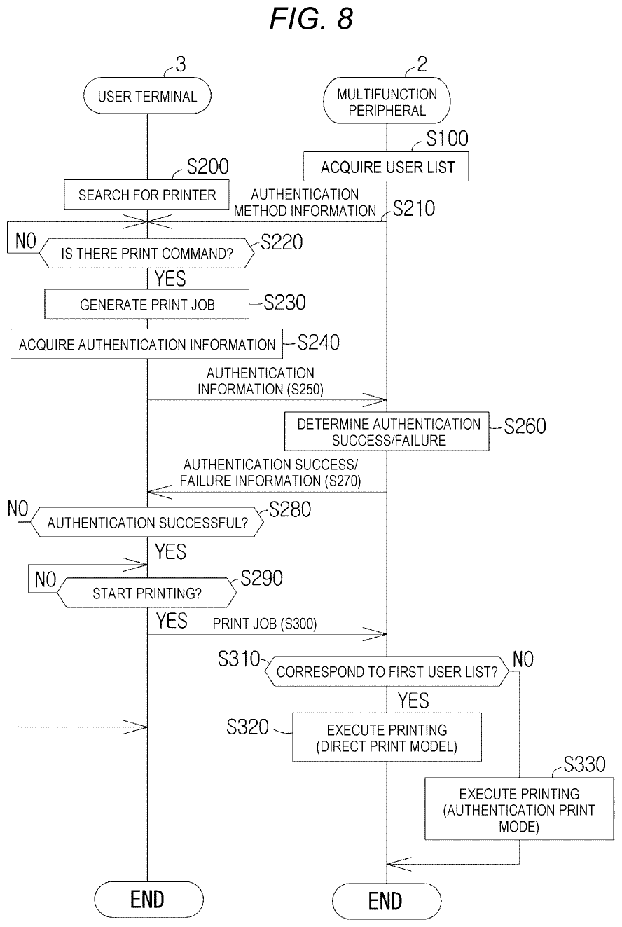

Next, a second embodiment of the present disclosure will be described with reference to FIGS. 5 to 8. Hereinafter, differences of the present embodiment with the first embodiment will be mainly described, and redundant description will be omitted. FIG. 5 is a schematic diagram of the printing system 1. FIG. 6 is a block diagram of the multifunction peripheral 2. FIG. 7 is a block diagram of a lightweight directory access protocol (LDAP) server 40. FIG. 8 is a control flow of the printing system 1.

As shown in FIG. 5, the printing system 1 further includes the LDAP server 40 in the present embodiment. The LDAP server 40 is a specific example of an external device. The multifunction peripheral 2 is configured to perform two-way communication with the LDAP server 40 via a LAN or a wide area network (WAN).

As shown in FIG. 6, the multifunction peripheral 2 includes a user list acquisition unit 50 instead of the user list storage unit 20 in the present embodiment. The user list acquisition unit 50 is a specific example of a list acquisition unit.

As shown in FIG. 7, the LDAP server 40 includes a processor 40a, a memory 40b, and a communication interface 40e. The LDAP server 40 communicates with the multifunction peripheral 2 via the communication interface 40e. The processor 40a can access the memory 40b. The processor 40a reads and executes a program stored in the memory 40b. The memory 40b constitutes a user list storage unit 41.

The user list storage unit 41 stores a first user list 41a and a second user list 41b. The first user list 41a includes the same data as the first user list 20a shown in FIG. 3. The second user list 41b includes the same data as the second user list 20b shown in FIG. 3.

The user list acquisition 50 of the multifunction peripheral 2 shown in FIG. 6 accesses the user list storage unit 41 of the LDAP server 40 to receive and acquire the first user list 41a and the second user list 41b from the LDAP server 40.

Next, a control flow of the printing system 1 will be described with reference to FIG. 8. The control flow shown in FIG. 8 mainly differs from the control flow shown in FIG. 5 in step S100.

### S100:

The user list acquisition unit 50 of the multifunction peripheral 2 accesses the LDAP server 40 to receive and acquire the latest first user list 41a and second user list 41b stored in the user list storage unit 41. The user list acquisition unit 50 of the multifunction peripheral 2 stores, in the memory 2b, the first user list 41a and the second user list 41b acquired from the LDAP server 40.

Hereinafter, in step S260, the authentication success/failure determination unit 23 performs the authentication success/failure determination with reference to the first user list 41a and the second user list 41b stored in the memory 2b. In step S310, the printing unit 25 determines, with reference to the first user list 41a stored in the memory 2b, whether the authentication information received by the authentication information reception unit 22 corresponds to the first user list 41a.

The second embodiment of the present disclosure is described above. The above second embodiment has the following features.

The multifunction peripheral 2 further includes the user list acquisition unit 50 (list acquisition unit) that acquires the first user list 41a and the second user list 41b from the LDAP server 40 (external device) including the user list storage unit 41 (list storage unit) storing the first user list 41a (first list) and the second user list 41b (second list). According to the above configuration, the first user list 41a and the second user list 41b can be managed by the LDAP server 40.

The above first embodiment and second embodiment can be modified, for example, as follows.

In each of the above embodiments, both the first user list 20a and the second user list 20b are implemented by a plurality of pieces of user information. However, instead of the user lists, the user list storage unit 20 may store a user account dedicated for direct printing and a user account dedicated for authentication printing. In this case, the expression that the authentication information received by the information reception unit 22 satisfies the first condition corresponds to the description that the authentication information received by the authentication information reception unit 22 corresponds to the user account dedicated for direct printing. The expression that the authentication information received by the authentication information reception unit 22 satisfies the second condition corresponds to the expression that the authentication information received by the authentication information reception unit 22 corresponds to the user dedicated for account authentication printing. When the authentication information received by the authentication information reception unit 22 satisfies the first condition, that is, when the authentication information received by the authentication information reception unit 22 corresponds to the user account dedicated for direct printing, the printing unit 25 may execute printing of the print job in accordance with the direct print mode 25a. In contrast, when the authentication information received by the authentication information reception unit 22 satisfies the second condition, that is, when the authentication information received by the authentication information reception unit 22 corresponds to the user account dedicated for authentication printing, the printing unit 25 may execute printing of the print job in accordance with the authentication print mode 25b.

In the above example, the program can be stored using various types of non-transitory computer readable medium and supplied to a computer. The non-transitory computer readable medium includes various types of tangible storage media. Examples of the non-transitory computer readable medium include a magnetic recording medium (for example, a flexible disk, a magnetic tape, or a hard disk drive) and a magneto-optical recording medium (for example, a magneto-optical disk). Examples of the non-transitory computer readable medium further include a CD-read only memory (ROM), a CD-R, a CD-R/W, and a semi-conductor memory (for example, a mask ROM). Examples of the non-transitory computer readable medium further include a programmable ROM (PROM), an erasable PROM (EPROM), a flash ROM, and a random access memory (RAM). The program may be supplied to the computer by various types of transitory computer readable media. Examples of the transitory computer readable medium include an electric signal, an optical signal, and an electromagnetic wave. The transitory computer readable medium can supply a program to the computer via a wired communication path such as an electric wire and an optical fiber or a wireless communication path.

What is claimed is:

1. An image forming device comprising:
an authentication information reception unit configured to receive authentication information from a user terminal; and
a printing unit configured to receive a print job from the user terminal, to execute printing of the print job in a direct print mode when the authentication information received by the authentication information reception unit satisfies a first condition, and to execute printing of the print job in an authentication print mode when the authentication information received by the authentication information reception unit satisfies a second condition different from the first condition.

2. The image forming device according to claim 1, wherein
the direct print mode is an operation mode in which an authentication operation is not requested to be performed on the image forming device before the printing of the print job is executed, and
the authentication print mode is an operation mode in which the authentication operation is requested to be performed on the image forming device before the printing of the print job is executed.

3. The image forming device according to claim 1, wherein
an expression that the authentication information received by the authentication information reception unit satisfies the first condition means that the authentication information received by the authentication information reception unit corresponds to a first list, and
an expression that the authentication information received by the authentication information reception unit satisfies the second condition means that the authentication information received by the authentication information reception unit corresponds to a second list different from the first list.

4. The image forming device according to claim 3, wherein
when the authentication information received by the authentication information reception unit corresponds to the first list, use of more functions of the image forming device is permitted as compared with the case where the authentication information received by the authentication information reception unit corresponds to the second list.

5. The image forming device according to claim 3, further comprising:
a list storage unit configured to store the first list and the second list.

6. The image forming device according to claim 3, further comprising:
a list acquisition unit configured to acquire the first list and the second list from an external device including a list storage unit configured to store the first list and the second list.

7. The image forming device according to claim 1, wherein
the printing unit executes the printing of the print job in the direct print mode when the authentication information received by the authentication information reception unit satisfies the first condition and the second condition at the same time.

8. The image forming device according to claim 1, wherein
the printing unit does not execute the printing of the print job when the authentication information received by the authentication information reception unit does not satisfy the first condition and the second condition.

9. The image forming device according to claim 1, wherein
the authentication information reception unit receives the authentication information from an OS standard printer driver of the user terminal.

10. A method for controlling an image forming device, the method comprising:
receiving authentication information from a user terminal; and
receiving a print job from the user terminal, executing printing of the print job in a direct print mode when the received authentication information satisfies a first condition, and executing the printing of the print job in an authentication print mode when the received authentication information satisfies a second condition different from the first condition.

11. A non-transitory computer-readable storage medium storing a program, the program causing an image forming device to execute:
receiving authentication information from a user terminal; and
receiving a print job from the user terminal, executing printing of the print job in a direct print mode when the received authentication information satisfies a first condition, and executing the printing of the print job in an authentication print mode when the received authentication information satisfies a second condition different from the first condition.
